(19) United States
(12) Patent Application Publication
(10) Pub. No.: US 2008/0284233 A1
(43) Pub. Date: Nov. 20, 2008

(54) Vehicle seat, in particular a shell-type seat

(75) Inventors: Martin Stiegler, Hattenhofen (DE); Frank Stunckel, Stadthagen (DE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: RECARO GmbH & Co. KG, Kirchheim unter Teck (DE)

(21) Appl. No.: 12/220,943

(22) Filed: Jul. 30, 2008

Related U.S. Application Data
(63) Continuation of application No. PCT/EP2007/000406, filed on Jan. 18, 2007.

(30) Foreign Application Priority Data
Feb. 1, 2006 (DE) 10 2006 004 566.1

(51) Int. Cl. B60R 22/26

(52) U.S. Cl. 297/485

(57) ABSTRACT

In the case of a vehicle seat, in particular a shell-type seat, having a backrest (4) over which a safety belt (G) can be guided in order to secure a seat occupant (F, M), the safety belt (G) can be placed in contact with a belt catch hook (10) that is attached to the backrest (4) and that laterally guides and/or holds a safety belt (G) engaged therein and allows a safety belt (G) disengaged therefrom to freely move laterally.

### CROSS-REFERENCE TO RELATED APPLICATION

The present application is a continuation of International Application PCT/EP2007/000406, which was filed Jan. 18, 2007. The entire disclosure of International Application PCT/EP2007/000406, which was filed Jan. 18, 2007, is incorporated herein by reference.

### TECHNICAL FIELD

The present invention relates to a vehicle seat, in particular a shell-type seat, having a backrest over which a safety belt can be guided in order to secure a seat occupant.

### BACKGROUND

Unless a vehicle seat is designed as a seat with an integrated seat belt system, or unless it has openings in the backrest through which two shoulder belts can pass, a section of a three-point safety belt is guided from a deflection fitting mounted on the B-pillar or on the C-pillar, over the backrest, to the shoulder of the seat occupant and further onwards across the chest and pelvic region of that person to the belt buckle. While in the case of vehicle seats having backrest frames the safety belt normally does not come into contact with the backrest, in the case of shell-type seats with a high backrest such contact may occur. In particular in the case of highly contoured shell-type seats and small seat occupants, the guidance of the belt may be impaired by this contact with the backrest, for example by the safety belt slipping laterally off along the contour of the backrest.

### BRIEF SUMMARY OF SOME ASPECTS OF THE DISCLOSURE

The object of the present invention is to improve a vehicle seat of the type mentioned in the Technical Field section of this disclosure.

In accordance with one aspect of the present invention, a vehicle seat, in particular a shell-type seat, has a backrest over which a safety belt can be guided in order to secure a seat occupant, and a belt catch hook is attached to the backrest. The safety belt can be placed in contact with the belt catch hook. The belt catch hook laterally guides and/or holds (e.g., restricts lateral movement of) a safety belt engaged therein. The belt catch hook allows a safety belt disengaged therefrom to freely move laterally.

By bringing the safety belt into contact with a belt catch hook attached to the backrest, the belt catch hook laterally guides and/or holds a safety belt that is engaged therein and allows a safety belt that is disengaged therefrom to freely move laterally, and the guiding of the safety belt can be adapted to the size of the seat occupant. Thus, in the case of a small seat occupant, the safety belt is preferably engaged in the belt catch hook, i.e. the guidance is determined by the belt catch hook, and in the case of a large seat occupant, the safety belt is disengaged, i.e. the guidance is determined by the shoulder of the seat occupant. The safety belt preferably engages and/or disengages automatically, depending on the size of the seat occupant. It is thus not necessary for the seat occupant to actively engage the belt in, or to disengage the belt from, the belt catch hook, and as a result the comfort level is increased and misuse is prevented.

In a preferred embodiment (e.g., optionally), the belt catch hook has a fin with a concave inner side and a convex outer side, and both the concave inner side and the convex outer side can both operate as functional surfaces. The safety belt engaged in the belt catch hook is preferably laterally guided and held by the inner side of the fin, for which purpose the concave shape has a stabilizing effect. The disengaged safety belt can be guided by the backrest or by the outer side of the fin, for which purpose the convex shape prevents the safety belt from becoming caught up.

The belt catch hook is preferably also provided with a base by means of which the belt catch hook is attached to the backrest and from which the fin preferably projects, wherein the belt catch hook is preferably formed in one piece, which simplifies its manufacture, for example, from a wear-resistant material. In addition, the base and the fin together can define a laterally open receptacle for the safety belt. The engaged safety belt is preferably laid over the upper side of the base, which thus supports the guiding function of the inner side of the fin.

The invention is preferably usable for vehicle seats whose backrest has a shell as its load-bearing structure, in particular a highly contoured shell, to which the belt catch hook is—preferably directly—attached. However, the invention is not restricted to such vehicle seats.

Other aspects and advantages of the present invention will become apparent from the following.

### BRIEF DESCRIPTION OF THE DRAWINGS

In the following, the invention is described in more detail on the basis of an exemplary embodiment shown in the drawings, in which:

FIG. 1 is a perspective partial view of the exemplary embodiment seen at an angle from behind, without a safety belt,

FIG. 2 is a schematic partial view of the exemplary embodiment, seen from the front with a safety belt and a small seat occupant,

FIG. 3 is a schematic partial view of the exemplary embodiment, seen from the front with a safety belt and a large seat occupant, and

FIG. 4 is a lateral view of the exemplary embodiment.

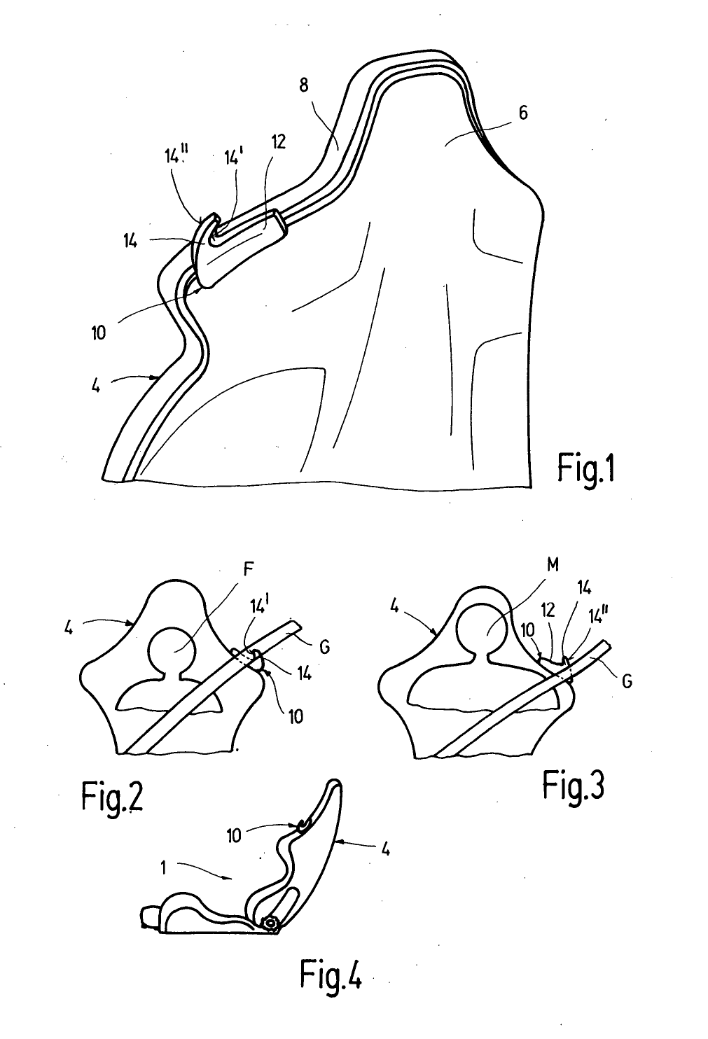

### DETAILED DESCRIPTION

A vehicle seat 1 is provided as a front seat for a motor vehicle. The vehicle seat 1, which is of shell-type construction, comprises a backrest 4 having a shell 6 as the load-bearing structure, padding and a cover 8. The padding and the cover 8 that covers the padding are arranged on the front side of the backrest 4, facing towards the seat occupant, with the cover 8 extending to each edge of the shell 6 where it is attached. The shell 6 is visible and uncovered at the rear side of the backrest 4. As far as the invention is concerned, it is insignificant whether the vehicle seat 1 is of double-shell construction (i.e. the shell 6 merely forms the load-bearing structure of the backrest 4 and the seat part has another load-bearing structure) or whether the vehicle seat 1 is of single-shell construction (i.e. the shell 6 also forms the load-bearing structure of the seat part).

In order to secure the seat occupant, a safety belt G is provided. In the exemplary embodiment, the safety belt G is a three-point safety belt that is deflected by the B-pillar among other things. A belt catch hook 10 is provided in the area of the shoulder of the seat occupant, on the backrest 4, in order to guide the safety belt G. In the exemplary embodiment, the belt catch hook 10 is mounted at the edge of the shell 6, on the side of the vehicle seat 1 that faces the B-pillar (door sill side). The belt catch hook 10 has a base 12 that is positioned on the edge of the shell 6 (and serves to attach the belt catch hook 10), as well as a single fin 14 that projects from the base 12. The term “fin” should be understood to mean generally at least a three-sided material area, for example triangular or curviform, having at least one convex outer side and at least one concave inner side. In the exemplary embodiment, the fin 14 projects at an oblique angle from the base 12 and is curved towards the center of the vehicle seat. The concave inner side 14′ of the fin 14 merges with a radius into the upper side of the base 12, i.e. the fin 14, with its concave inner side 14′ and the base 12 with its upper side define a receptacle that is open laterally or, more precisely stated, with an upward vertical component (e.g., an opening of the receptacle is both laterally and upwardly open). The convex outer side 14″ of the fin 14 points towards the sill side. The entire belt catch hook 10 is manufactured preferably from an impact-resistant plastic such as PA6 GF30, so that it is protected from wear, but it may also be made from metal or a composite material.

The belt catch hook 10 is especially advantageous in the case of a small seat occupant F, e.g. a 5-percentile woman. Then, the safety belt G, from the deflection fitting on the B-pillar, is placed across the base 12 (i.e. across the upper side thereof). The safety belt G engages automatically in the belt catch hook 10 or, more precisely stated, in the receptacle defined by the inner side 14′ of the fin 14 and by the base 12. The safety belt G is thus laterally held and guided at the sill-side edge of the belt by the inner side 14′ of the fin 14. The safety belt G is further guided over the area between the shoulder and the neck of the small seat occupant F to the belt buckle. This automatic engagement of the safety belt G in the belt catch hook 10 prevents the safety belt G from slipping laterally off the shell 6, due to the extensive contouring of the shell 6, and thus also off the shoulder of the small seat occupant F. When necessary, the safety belt G can be easily disengaged again from the belt catch hook 10, for example if the backrest 4 should be free-pivoted in order to gain access to the rear compartment.

In the case of a large seat occupant M, for example a 50-percentile man or a 95-percentile man, the shoulder is higher, so that the belt catch hook 10 does not need to laterally guide the safety belt G. The safety belt G disengages itself automatically—at the latest when it is put on—from the belt catch hook 10 and instead runs over the shoulder of the large seat occupant M. Typically in this case, the safety belt G runs above the belt catch hook 10 and does not come into contact at all with the belt catch hook 10 or the backrest 4, so that the safety belt G cannot slip off the backrest 4 or, more precisely stated, off the shell 6. If the safety belt G does, however, come into contact with the backrest 4, the fin 14 can guide the safety belt G with its outer side 14″, or the safety belt G comes into contact with the edge of the backrest 4 in an area above the belt catch hook 10. In both cases, the safety belt G is laterally freely movable, for example because of the convex shape of the outer side 14″ of the fin 14, i.e. the safety belt G does not get caught up.

It will be understood by those skilled in the art that while the present invention has been discussed above with reference to an exemplary embodiment, various additions, modifications and changes can be made thereto without departing from the spirit and scope of the invention as set forth in the following claims.

That which is claimed:

1. A vehicle seat for being sat in by a seat occupant, which may be a relatively small seat occupant or a relatively large seat occupant, and for use with a safety belt for securing the seat occupant sitting in the vehicle seat, the vehicle seat comprising:
a backrest adapted for having the safety belt guided over the backrest in order to secure the seat occupant sitting in the vehicle seat;
a belt catch hook attached to the backrest; and
the belt catch hook being positioned and adapted for
having the safety belt engaged in the belt catch hook while the small seat occupant is secured in the vehicle seat with the safety belt,
restricting lateral movement of the safety belt while the safety belt is engaged in the belt catch hook,
having the safety belt disengaged from the belt catch hook while the large seat occupant is secured in the vehicle seat with the safety belt, and
allowing the safety belt to freely move laterally while the safety belt is disengaged from the belt catch hook.

2. The vehicle seat according to claim 1, wherein the belt catch hook is positioned and adapted so that, when the safety belt is disengaged from the belt catch hook and then the small seat occupant is secured in the vehicle seat with the safety belt, the safety belt automatically engages in the belt catch hook in response to the small seat occupant being secured in the vehicle seat with the safety belt.

3. The vehicle seat according to claim 1, wherein the belt catch hook has:
a base, wherein the belt catch hook is attached to the backrest by way of the base, and
a single fin that projects from the base.

4. The vehicle seat according to claim 3, wherein the fin has a concave inner side.

5. The vehicle seat according to claim 4, wherein the concave inner side of the fin is part of a receptacle that is for being in receipt of the safety belt while the safety belt is engaged in the belt catch hook, the receptacle defines an opening that is laterally open, and the safety belt is outside of the receptacle while the safety belt is disengaged from the belt catch hook.

6. The vehicle seat according to claim 5, wherein the safety belt engaged in the belt catch hook is guided and held laterally by the receptacle.

7. The vehicle seat according to claim 3, wherein the safety belt is laying over an upper side of the base while the safety belt is engaged in the belt catch hook.

8. The vehicle seat according to claim 2, wherein:
the belt catch hook comprises a projecting fin; and
while the safety belt is disengaged from the belt catch hook due to the large seat occupant being secured in the vehicle seat with the safety belt, the safety belt is guided by at least one feature selected from the group consisting of
the large seat occupant's shoulder,
an outer side of the fin, and
an edge of the backrest.

9. The vehicle seat according to claim 1, wherein:
the belt catch hook is made of impact-resistant plastic or metal;
the belt catch hook consists essentially of a base and a single fin that projects from the base so that the base and the single fin together form a single receptacle for receiving the safety belt; and
the belt catch hook is attached to the backrest by way of the base.

10. The vehicle seat according to claim 1, wherein:
the backrest comprises a load-bearing structure;
the load-bearing structure of the backrest is a shell; and
the belt catch hook is attached to the shell.

11. The vehicle seat according to claim 1, wherein the belt catch hook is positioned and adapted so that, when the safety belt is engaged in the belt catch hook and then the large seat occupant is secured in the vehicle seat with the safety belt, the safety belt automatically disengages from the belt catch hook in response to the large seat occupant being secured in the vehicle seat with the safety belt, and the safety belt remains disengaged from the belt catch hook while the large seat occupant is secured in the vehicle seat with the safety belt.

12. The vehicle seat according to claim 1, wherein the belt catch hook has a single fin that projects from the backrest.

13. The vehicle seat according to claim 2, wherein the belt catch hook comprises a fin, the fin has opposite inner and outer sides, the inner side is concave, and the outer side is convex.

14. The vehicle seat according to claim 4, wherein the safety belt engaged in the belt catch hook is guided and held laterally by the concave inner side of the fin.

15. The vehicle seat according to claim 5, wherein the receptacle consists essentially of the concave inner side of the fin and an upper side of the base, and the opening of the receptacle is also upwardly open.

16. A vehicle seat for being sat in by a seat occupant, and for use with a safety belt for securing the seat occupant sitting in the vehicle seat, the vehicle seat comprising:
a backrest adapted for having the safety belt guided over the backrest in order to secure the seat occupant sitting in the vehicle seat;
a belt catch hook consisting essentially of a base and a single fin that projects from the base so that the base and the single fin together form a single receptacle defining an opening that is laterally open for removably receiving the safety belt;
the base of the belt catch hook being attached to the backrest; and
the base extends upwardly from a lower end of the fin so that an upper surface of the base is for
having the safety belt lain over the upper side of the base, and
guiding the safety belt into the receptacle.

17. The vehicle seat according to claim 16, wherein the opening of the receptacle is also upwardly open.

18. The vehicle seat according to claim 16, wherein:
the backrest comprises a load-bearing structure;
the load-bearing structure of the backrest is a shell;
a portion of the shell extends obliquely;
the base of the belt catch hook is attached to the portion of the shell that extends obliquely so that the base has an upper end and a lower end;
the fin projects from the lower end of the base so that the fin obstructs access to the receptacle from the lower end of the base; and
the belt catch hook is configured to provide unobstructed access to the receptacle from the upper end of the base.

19. A vehicle seat for being sat in by a seat occupant, which may be a relatively small seat occupant or a relatively large seat occupant, and for use with a safety belt for securing the seat occupant sitting in the vehicle seat, the vehicle seat comprising:
a backrest adapted for having the safety belt guided over the backrest in order to secure the seat occupant sitting in the vehicle seat, the backrest comprises a load-bearing structure, and the load-bearing structure of the backrest comprises a shell;
a belt catch hook attached to the shell, wherein the belt catch hook comprises a fin, an inner side of the fin is part of a receptacle, and the receptacle has an opening that is laterally open for removably receiving the safety belt;
the belt catch hook being positioned and adapted for
having the safety belt within the receptacle and thereby engaged in the belt catch hook while the small seat occupant is secured in the vehicle seat with the safety belt,
restricting lateral movement of the safety belt while the safety belt is within the receptacle and thereby engaged in the belt catch hook,
having the safety belt outside of the receptacle and thereby disengaged from the belt catch hook while the large seat occupant is secured in the vehicle seat with the safety belt, and
allowing the safety belt to freely move laterally while the safety belt is outside of the receptacle; and
the belt catch hook being positioned and adapted so that, when the safety belt is outside of the receptacle and then the small seat occupant is secured in the vehicle seat with the safety belt, the safety belt automatically moves into the receptacle via the opening in response to the small seat occupant being secured in the vehicle seat with the safety belt, so that the safety belt automatically engages in the belt catch hook in response to the small seat occupant being secured in the vehicle seat with the safety belt.

20. The vehicle seat according to claim 19, wherein
a portion of the shell extends obliquely;
the belt catch hook is attached to the portion of the shell that extends obliquely; and
the opening of the receptacle is also upwardly open.
